(19) United States
(12) Patent Application Publication
(10) Pub. No.: US 2014/0067394 A1
(43) Pub. Date: Mar. 6, 2014

(54) SYSTEM AND METHOD FOR DECODING SPEECH

(71) Applicants: DIA EDDIN M. ABUZEINA, HEBRON (PS); MOUSTAFA ELSHAFEI, DHAHRAN (SA); HUSNI AL-MUHTASEB, DHAHRAN (SA); WASFI G. AL-KHATIB, DHAHRAN (SA)

(72) Inventors: DIA EDDIN M. ABUZEINA, HEBRON (PS); MOUSTAFA ELSHAFEI, DHAHRAN (SA); HUSNI AL-MUHTASEB, DHAHRAN (SA); WASFI G. AL-KHATIB, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/597,162

(22) Filed: Aug. 28, 2012

(51) Int. Cl. G10L 15/06

(52) U.S. Cl. 704/244; 704/E15.007

(57) ABSTRACT

The system and method for speech decoding in speech recognition systems provides decoding for speech variants common to such languages. These variants include within-word and cross-word variants. For decoding of within-word variants, a data-driven approach is used, in which phonetic variants are identified, and a pronunciation dictionary and language model of a dynamic programming speech recognition system are updated based upon these identifications. Cross-word variants are handled with a knowledge-based approach, applying phonological rules, part-of-speech tagging or tagging of small words to a speech transcription corpus and updating the pronunciation dictionary and language model of the dynamic programming speech recognition system based upon identified cross-word variants.

### BACKGROUND OF THE INVENTION

1. Field of the Invention

The present invention relates to speech recognition software, and particularly to a speech decoding system and method for handling within-word and cross-word phonetic variants in spoken language, such as those associated with spoken Arabic.

2. Description of the Related Art

The primary goal of automatic speech recognition systems (ASRs) is to enable people to communicate more naturally and effectively. However, this goal faces many obstacles, such as variability in speaking styles and pronunciation variations. Although speech recognition systems are known for the English language and various Romance and Germanic languages, Arabic speech presents specific challenges in effective speech recognition that conventional speech recognition systems are not adapted to handle.

FIG. 2 illustrates a conventional speech recognition system 200 utilizing dynamic programming. Dynamic programming is typically used for both discrete-utterance recognition (DUR) and connected-speech recognition (CSR) systems. Speech is entered into the system 200 by a conventional microphone 210 or the like. An analog-to-digital converter 220 generates a digital signal from the uttered speech, and signal processing hardware and software in block 240 develops a pattern, or feature vector, for some short time interval of the speech signal. Typically, feature vectors are based on between 5 ms and 50 ms of the speech data and are of typical vector dimensions of between 5 and 50.

Analysis intervals are usually overlapped (i.e., correlated), although there are some systems, typically synchronous, where the analysis intervals are not overlapped (i.e., independent). For speech recognition to work in near real time, this phase of the system must operate in real time.

Many feature sets have been proposed and implemented for dynamic programming systems, such as system 200, including many types of spectral features (i.e., log-energy estimates in several frequency hands), features based on a model of the human car, features based on linear predictive coding (LPC) analysis, and features developed from phonetic knowledge about the semantic component of the speech. Given this variety, it is fortunate that the dynamic programming mechanism is essentially independent of the specific feature vector selected. For illustrative purposes, the prior art system 200 utilizes a feature vector formed from L log-energy values of the spectrum of a short interval of speech.

Any feature vector is a function of l, the index on the component of the vector (i.e., the index on frequency for log-energy features) and a function of the time index i. The latter may or may not be linearly related to real time. For asynchronous analysis, the speech interval for analysis is advanced a fixed amount for each feature vector, which implies i and time are linearly related. For synchronous analysis, the interval of speech used for each feature vector varies as a function of the pitch and/or events in the speech signal itself, in which case i will only index feature vectors and must be related to time through a lookup table. This implies i^{th} feature vector≡f(i,l). Thus, each pattern or data stream for recognition may be visualized as an ensemble of feature vectors.

In dynamic programming DUR and CSR, it is assumed that some set of pre-stored ensembles of feature vectors is available. Each member is called a prototype, and the set is indexed by k; i.e., k^{th} prototype≡Pₖ. The prototype data is stored in a prototype storage area 260 of computer readable memory. The l^{th} component of the i^{th} feature vector for the k^{th} prototype is, therefore, Pₖ(i,l). Similarly, the data for recognition are represented as the candidate feature vector ensemble, Candidate≡C.

The l^{th} component of the i^{th} feature vector of the candidate will be C(i,l). The problem for recognition is to compare each prototype against the candidate, select the one that is, in some sense, the closest match, the intent being that the closest match is appropriately associated with the spoken input. This matching is performed in a dynamic programming match step 280, and once matches have been found, the final string recognition output 290 is stored and/or presented to the user.

There are many algorithms that are conventionally used for matching a candidate and prototype. Some of the more successful techniques include network-based models and hidden Markov models (HMMs) applied at both the phoneme and at the word. However, dynamic programming remains the most widely used algorithm for real-time recognition systems.

There are many varieties of speech recognition algorithms. For smaller vocabulary systems, a set of one or more prototypes is stored for each utterance in the vocabulary. This structure has been used both for talker-trained and talker-independent systems, as well as for DUR and CSR. When the recognition task for a large vocabulary (over 1,000 utterances), or even a talker-independent medium-sized vocabulary (100-999 utterances) is considered, the use of a large set of pre-stored word or utterance-level prototypes is, at best, cumbersome. For these systems, parsing to the syllabic or phonetic level is reasonable.

In speech recognition, pronunciation variation causes recognition errors in the form of insertions, deletions, or substitutions of phoneme(s) relative to the phonemic transcription in the pronunciation dictionary. Pronunciation variations that reduce recognition performance occur in continuous speech in two main categories, cross-word variation and within-word variation. Arabic speech presents unique challenges with regard to both cross-word variations and within-word variations. Within-word variations cause alternative pronunciation(s) within words. In contrast, a cross-word variation occurs in continuous speech when a sequence of words forms a compound word that should be treated as one entity.

Cross-word variations are particularly prominent in Arabic, due to the wide use of phonetic merging (“idgham” in Arabic), phonetic changing (“iqlaab” in Arabic), Hamzat Al-Wasl deleting, and the merging of two consecutive unvoweled letters. It has been noticed that short words are more frequently misrecognized in speech recognition systems. In general, errors resulting from small words are much greater than errors resulting from long words. Thus, the compounding of some words (small or long) to produce longer words is a technique of interest when dealing with cross-word variations in speech recognition decoders.

The pronunciation variations are often modeled using two approaches, knowledge-based and data-driven techniques. The knowledge-based approach depends on linguistic criteria that have been developed over decades. These criteria are presented as phonetic rules that can be used to find the possible pronunciation alternative(s) for word utterances. On the other hand, data-driven methods depend solely on the training pronunciation corpus to find the pronunciation variants (i.e., direct data-driven) or transformation rules (i.e., indirect data-driven).

The direct data-driven approach distills variants, while the indirect data-driven approach distills rules that are used to find variants. The knowledge-based approach is, however, not exhaustive, and not all of the variations that occur in continuous speech can be described. For the data-driven approach, obtaining reliable information is extremely difficult. In recent years, though, a great deal of work has gone into the data-driven approach in attempts to make the process more efficient, thus allowing the data-driven approach to supplant the flawed knowledge-based approach. It would be desirable to provide a data-driven approach that can easily handle the types of variations that are inherent in Arabic speech.

Thus, a system and method for decoding speech solving the aforementioned problems are desired.

### SUMMARY OF THE INVENTION

The system and method for decoding speech relates to speech recognition software, and particularly to a speech decoding system and method for handling within-word and cross-word phonetic variants in spoken language, such as those associated with spoken Arabic. For decoding within-word variants, the pronunciation dictionary is first established for a particular language, such as Arabic, and the pronunciation dictionary is stored in computer readable memory. The pronunciation dictionary includes a plurality of words, each of which is divided into phonemes of the language, where each phoneme is represented by a single character. The acoustic model for the language is then trained. The acoustic model includes hidden Markov models corresponding to the phonemes of the language. The trained acoustic model is stored in the computer readable memory. The language model is also trained for the language. The language model is an N-gram language model containing probabilities of particular word sequences from a transcription corpus. The trained language model is also stored in the computer readable memory.

The system receives at least one spoken word in the language and generates a digital speech signal corresponding the at least one spoken word. Phoneme recognition is then performed on the speech signal to generate a set of spoken phonemes of the at least one word. The set of spoken phonemes is stored in the computer readable memory. Each spoken phoneme is represented by a single character.

Typically, some phonemes are represented by two or more characters. However, in order to perform sequence alignment and comparison against the phonemes of the dictionary, each phoneme must be represented by only a single character. The phonemes of the dictionary are also represented as such. For the same purpose, any gaps in speech of the spoken phonemes are removed from the speech signal.

Sequence alignment is then performed between the spoken phonemes of the at least one word and a set of reference phonemes of the pronunciation dictionary corresponding to the at least one word. The spoken phonemes of the at least one word and the set of reference phonemes of the pronunciation dictionary corresponding to the at least one word are compared against one another to identify a set of unique variants therebetween. This set of unique variants is then added to the pronunciation dictionary and the language model to update each, thus increasing the probability of recognizing speech containing such variations.

For the identified unique variants, following identification thereof, any duplicates are removed prior to updating the language model and the dictionary, and any spoken phonemes that were reduced to a single character representation from a multiple character representation are restored back to their multi-character representations. Further, prior to the step of updating of the dictionary and the language model, orthographic forms are generated for each identified unique variant. In other words, a new artificial word representing the phonemes in terms of letters is generated for recordation thereof in the dictionary and language model.

For performing cross-word decoding in speech recognition, a knowledge-based approach is used, particularly using two phonological rules common in Arabic speech, namely the rules of merging (“Idgham”) and changing (“Iqlaab”). As in the previous method, this method makes primary use of the pronunciation dictionary and the language model. The dictionary and the language model are both expanded according to the cross-word cases found in the corpus transcription. This method is based on the compounding of words.

Cross-word starts are first identified and extracted from the corpus transcription. The phonological rules to be applied are then specified. In this particular case, the rules are merging (Idgham) and changing (Iqlaab). A software tool is then used to extract the compound rules from the baseline corpus transcription. Following extraction of the compound words, the compound words are then added to the corpus transcription within their sentences. The original sentences (i.e., without merging) remain in the enhanced corpus transcription. This method maintains both cases of merged and separated words.

The enhanced corpus is then used to build the enhanced dictionary. The language model is built according to the enhanced corpus transcription. In other words, the compound words in the enhanced corpus transcription will be involved in the unigrams, bigrams, and trigrams of the language model. Then, during the recognition process, the recognition result is scanned for decomposing compound words to their original state (i.e., two separated words). This is performed using a lookup table.

In an alternative method for cross-word variants, two pronunciation cases are considered, namely, nouns followed by an adjective, and prepositions followed by any word. This is of particular interest when it is desired to compound some words as one word. This method is based on the Arabic tags generated by the Stanford Part-of-Speech (PoS) Arabic language tagger, created by the Stanford Natural Language Processing Group of Stanford University, of Stanford Calif., which consists of 29 different tags. The tagger output is used to generate compound words by searching for noun-adjective and preposition-word sequences.

In a further alternative method for cross-word variant decoding, cross-word modeling may be performed by using small word merging. Unlike isolated speech, continuous speech is known to be a source of augmenting words. This augmentation depends on many factors, such as the phonology of the language and the lengths of the words. Decoding may thus be focused on adjacent small words as a source of the merging of words. Modeling of the small-word problem is a data-driven approach in which a compound word is distilled from the corpus transcription. The compound word length is the total length of the two adjacent small words that form the corresponding compound word. The small word's length could be two, three, or four or more letters.

These and other features of the present invention will become readily apparent upon further review of the following specification and drawings.

### BRIEF DESCRIPTION OF THE DRAWINGS

FIG. 1 is a block diagram showing an overview of a system and method for decoding speech according to the present invention.

FIG. 2 is a block diagram illustrating a conventional prior art dynamic programming-based speech recognition system.

FIG. 3 is a block diagram illustrating a computer system for implementing the method for decoding speech.

Similar reference characters denote corresponding features consistently throughout the attached drawings.

### DETAILED DESCRIPTION OF THE PREFERRED EMBODIMENTS

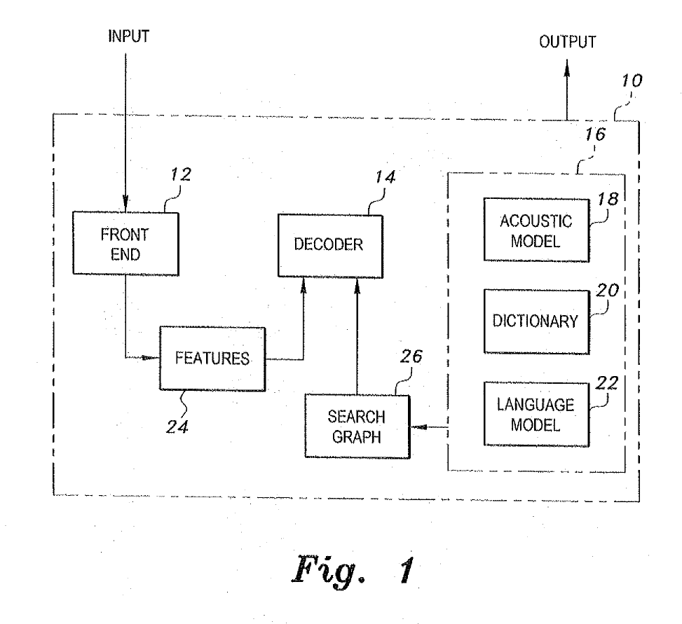

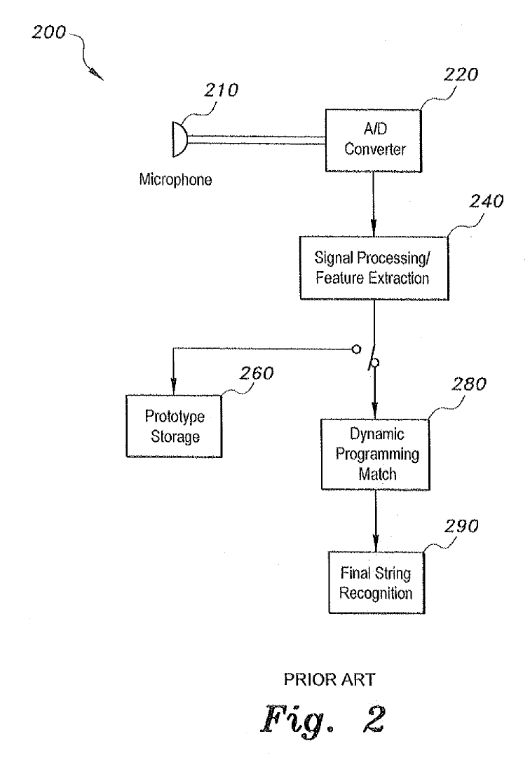

In a first embodiment of the system and method for decoding speech, a data-driven speech recognition approach is utilized. This method is used to model within-word pronunciation variations, in which the pronunciation variants are distilled from the training speech corpus. The speech recognition system 10, shown in FIG. 1, includes three knowledge sources contained within a linguistic module 16. The three knowledge sources include an acoustic model 18, a language model (LM) 22, and a pronunciation dictionary 20. The linguistic module 16 corresponds to the prototype storage 260 of the prior art system of FIG. 2. The dictionary 20 provides pronunciation information for each word in the vocabulary in phonemic units, which are modeled in detail by the acoustic models 18. The language model 22 provides the a priori probabilities of word sequences. The acoustic model 18 of the system 10 utilizes hidden Markov models (HMMs), stored therein for the recognition process. The language model 22 contains the particular language's words and its combinations, each combination containing two or more words. The pronunciation dictionary 20 contains the words of the language. The dictionary 20 represents each word in terms of phonemes.

The front end 12 of the system 10 extracts speech features 24 from the spoken input, corresponding to the microphone 210, the A/D converter 220 and the feature extraction module 240 of the prior art system of FIG. 2. The present system 10 relies on Mel-frequency cepstral coefficients (MFCC) as the extracted features 24. As with the system of FIG. 2, the features extraction stage aims to produce the spectral properties (i.e., features vectors) of the input speech signal. In the present system, these properties consist of a set of 39 coefficients of MFCCs. The speech signal is divided into overlapping short segments that will be represented using MFCCs.

The decoder 14, with help from the linguistic module 16, is the module where the recognition process takes place. The decoder 14 uses the speech features 24 presented by the front end 12 to search for the most probable matching words (corresponding to the dynamic programming match 280 of the prior art system of FIG. 2), and then sentences that correspond to observation speech features 24. The recognition process of the decoder 14 starts by finding the likelihood of a given sequence of speech features based on the phonemes' HMMs. The decoder 14 uses the known Viterbi algorithm to find the highest scoring state sequence.

The acoustic model 18 is a statistical representation of the phoneme. Precise acoustic modeling is a key factor in improving recognition accuracy, as it characterizes the HMM of each phoneme. The present system uses 39 separate phonemes. The acoustic model 18 further uses a 3-state to 5-state Markov chain to represent the speech phoneme.

The system 10 further utilizes training via the known Baum-Welch algorithm in order to build the language model 22 and the acoustic model 18. In a natural language speech recognition system, the language model 22 is a statistically based model using unigram, bigrams, and trigrams of the language for the text to be recognized. On the other hand, the acoustic model 18 builds the HMMs for all the triphones and the probability distribution of the observations for each state in each HMM.

The training process for the acoustic model 18 consists of three phases, which include the context-independent phase, the context-dependent phase, and the tied states phase. Each of these consecutive phases consists of three stages, which include model definition, model initialization, and model training. Each phase makes use of the output of the previous phase.

The context-independent (CI) phase creates a single HMM for each phoneme in the phoneme list. The number of states in an HMM model can be specified by the developer. In the model definition stage, a serial number is assigned for each state in the whole acoustic model. Additionally, the main topology for the HMMs is created. The topology of an HMM specifies the possible state transitions in the acoustic model 18, and the default is to allow each state to loop back and move to the next state. However, it is possible to allow states to skip to the second next state directly. In the model initialization stage, some model parameters are initialized to some calculated values. The model training stage consists of a number of executions of the Baum-Welch algorithm (5 to 8 times), followed by a normalization process.

In the untied context-dependent (CD) phase, triphones are added to the HMM set. In the model definition stage, all the triphones appearing in the training set will be created, and then the triphones below a certain frequency are excluded. Specifying a reasonable threshold for frequency is important for the performance of the model. After defining the needed triphones, states are given serial numbers as well (continuing the same count). The initialization stage copies the parameters from the CI phase. Similar to the previous phase, the model training stage consists of a number of executions of the Baum-Welch algorithm followed by a normalization process.

The tied context-dependent phase aims to improve the performance of the model generated by the previous phase by tying some states of the HMMs. These tied states are called “Senones”. The process of creating these Senones involves building some decision trees that are based on some “linguistic questions” provided by the developer. For example, these questions could be about the classification of phonemes according to some acoustic property. After the new model is defined, the training procedure continues with the initializing and training stages. The training stage for this phase may include modeling with a mixture of normal distributions. This may require more iterations of the Baum-Welch algorithm.

Determination of the parameters of the acoustic model 18 is referred to as training the acoustic model. Estimation of the parameters of the acoustic model is performed using Baum-Welch re-estimation, which tries to maximize the probability of the observation sequence, given the model.

The language model 22 is trained by counting N-gram occurrences in a large transcription corpus, which is then smoothed and normalized. In general, an N-gram language model is constructed by calculating the probability for all combinations that exist in the transcription corpus. As is known, the language model 22 may be implemented as a recognizer search graph 26 embodying a plurality of possible ways in which a spoken request could be phrased.

The method includes the following steps. First, the pronunciation dictionary is established for a particular language, such as Arabic, and the pronunciation dictionary is stored in computer readable memory. The pronunciation dictionary includes a plurality of words, each of which is divided into phonemes of the language, where each phoneme is represented by a single character. The acoustic model for the language is then trained, the acoustic model including hidden Markov models corresponding to the phonemes of the language. The trained acoustic model is stored in the computer readable memory. The language model is also trained for the language, the language model being an N-gram language model containing probabilities of particular word sequences from a transcription corpus. The trained language model is also stored in the computer readable memory.

The system receives at least one spoken word in the language and generates a digital speech signal corresponding to the at least one spoken word. Phoneme recognition is then performed on the speech signal to generate a set of spoken phonemes of the at least one word, the set of spoken phonemes being recorded in the computer readable memory. Each spoken phoneme is represented by a single character.

Typically, some phonemes are represented by two or more characters. However, in order to perform sequence alignment and comparison against the phonemes of the dictionary, each phoneme must be represented by only a single character. The phonemes of the dictionary are also represented as such. For the same purpose, any gaps in speech of the spoken phonemes are removed from the speech signal.

Sequence alignment is then performed between the spoken phonemes of the at least one word and a set of reference phonemes of the pronunciation dictionary corresponding to the at least one word. The spoken phonemes of the at least one word and the set of reference phonemes of the pronunciation dictionary corresponding to the at least one word are compared against one another to identify a set of unique variants therebetween. This set of unique variants is then added to the pronunciation dictionary and the language model to update each, thus increasing the probability of recognizing speech containing such variations.

For the identified unique variants, following identification thereof, any duplicates are removed prior to updating the language model and the dictionary, and any spoken phonemes that were reduced to a single character representation from a multiple character representation are restored back to their multi-character representations. Further, prior to the step of updating of the dictionary and the language model, orthographic forms are generated for each identified unique variant. In other words, a new artificial word representing the phonemes in terms of letters is generated for recordation thereof in the dictionary and language model.

Since the phoneme recognizer output has no boundary between the words, the direct data-driven approach is a good candidate to extract variants where no boundary information is present. This approach is known and is typically used in bioinformatics to align gene sequences.

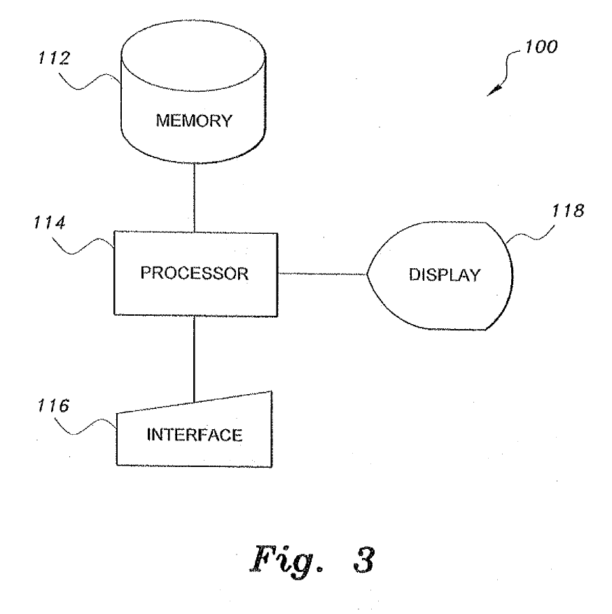

It should be understood that the calculations may be performed by any suitable computer system, such as the system 100 diagrammatically shown in FIG. 3. Data is entered into the system 100 via any suitable type of user interface 116, and may be stored in memory 112, which may be any suitable type of computer readable and programmable memory and is a non-transitory, computer readable storage medium. Calculations are performed by the processor 114, which may be any suitable type of computer processor and may be displayed to the user on a display 118, which may be any suitable type of computer display.

The processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

As used herein, the term “computer readable media” includes any form of non-transitory memory storage. Examples of computer-readable recording media include a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Table 1 below shows experimental results for the above method, testing the accuracy of the above method with actual Arabic speech. The following are a number of assumptions applied during the testing phase. First, the sequence alignment method was determined to be a good option to find variants for long words. Thus, experiments were performed on word lengths (WL) of seven characters or more ((including diacritics). Small words were avoided. Next, the same Levenshtein Distance (LD) threshold was not used for all word lengths. The Levenshtein. Distance (LD) is a metric for measuring the difference between two sequences. In the present case, the difference is between the speech phonemes and the stored reference phonemes. A small LD threshold was used for small words and larger LD thresholds were used for long words. Last, the following sequence alignment scores were used: Match score=10, Mismatch score=−7, Gap score=−4.

Eight separate tests were performed. Table 1 shows the recognition output achieved for different choices of LD threshold. The highest accuracy was found in Experiment 6, having the following specifications. The WL starts at 12 characters. For a WL with 12 or 13 characters, LD=1 or 2. This means that once a variant is found, the LD should be 1 or 2 to be an accepted variant. For the other WLs in Experiment 6, LDs are also applied in the same way.

TABLE 1
Accuracy of Within-Word Speech Decoding Method

Experiment

| | 1 | 2 | 3 | 4 |
|---|---|---|---|---|
| | WL | WL | WL | WL |
| LD = 1-2 | 7-8 | 8-9 | 9-10 | 10-11 |
| LD = 1-3 | 9-12 | 10-13 | 11-14 | 12-15 |
| LD = 1-4 | ≧13 | ≧14 | ≧15 | ≧16 |
| Accuracy % | 89.1 | 89.25 | 89.45 | 89.42 |
| Enhancement % | 1.31 | 1.46 | 1.66 | 1.63 |
| Used Variants | 298 | 248 | 181 | 140 |

Experiment

| | 5 | 6 | 7 | 8 |
|---|---|---|---|---|
| | WL | WL | WL | WL |
| LD = 1-2 | 11-12 | 12-13 | 13-14 | 14-15 |
| LD = 1-3 | 13-16 | 14-17 | 15-18 | 16-19 |
| LD = 1-4 | ≧17 | ≧18 | ≧19 | ≧20 |
| Accuracy % | 89.54 | 89.61 | 89.31 | 88.48 |
| Enhancement % | 1.75 | 1.82 | 1.52 | 0.69 |
| Used Variants | 97 | 60 | 34 | 15 |

The greatest accuracy was found in Experiment 6, which had an overall accuracy of 89.61%. Compared against a conventional baseline control speech recognition system, which gave an accuracy of 87.79%, the present method provided a word error rate (WER) reduction of 1.82%. Table 2 below provides statistical information regarding the variants. It shows the total variants found using the present method. Table 2 also shows how many variants (among the total) are already found in the dictionary, alleviating the need to be accepted. After discarding the found variants, the system is left with the candidate variants that will be considered in the modeling process. After discarding the repetitions, the resultant is the set of unique variants. The column on the right in Table 2 shows how many variants were used (i.e., replaced back) after the decoding process.

TABLE 2
Variant Statistics of Within-Word Speech Decoding Method

| | Total | Variants in | Candidate | Unique | Variants |
|---|---|---|---|---|---|
| Experiment | Variants | Dictionary | Variants | Variants | Used |
| 1 | 7120 | 2965 | 4155 | 3793 | 298 |
| 2 | 5118 | 1901 | 3217 | 2959 | 248 |
| 3 | 3660 | 1224 | 2436 | 2259 | 181 |
| 4 | 2412 | 771 | 1641 | 1513 | 140 |
| 5 | 1533 | 446 | 1087 | 994 | 97 |
| 6 | 854 | 241 | 613 | 569 | 60 |
| 7 | 455 | 119 | 336 | 313 | 34 |
| 8 | 217 | 56 | 161 | 150 | 15 |

Table 2 above shows that 26%-42% among suggested variants are already known to the dictionary. This metric could be used as an indicator of the selection process. In general, it should be as low as possible in order to introduce new variants. Table 2 also shows that 8% of the variants are discarded due to the repetitions. This repetition is an important issue in pronunciation variation modeling, as it may use the highest frequency variants in the modeling process. Table 3 below lists information from two experiments (experiments 5 and 6) that have the highest accuracy. Table 3 shows that most variants have a one-time repetition. Table 3 further shows that the repetition could reach eight times for some variants.

TABLE 3
Frequency of Variants

| | Variants' Frequency | | | | | | | |
|---|---|---|---|---|---|---|---|---|
| Experiment | 1 | 2 | 3 | 4 | 5 | 6 | 7 | 8 |
| 5 | 1034 | 38 | 7 | 3 | 0 | 1 | 1 | 3 |
| | 95% | 3.5% | ≈0% | ≈0% | 0% | ≈0% | ≈0% | ≈0% |
| 6 | 584 | 23 | 4 | 0 | 0 | 0 | 1 | 1 |
| | 95% | 3.7% | ≈0% | 0% | 0% | 0% | ≈0% | ≈0% |

The above method produced a word error rate (WER) of only 10.39% and an out-of-vocabulary error of only 3.39%, compared to 3.53% in the baseline control system. Perplexity from Experiment #6 of the above method was 6.73, compared with a perplexity of the baseline control model of 34.08 (taken for a testing set of 9,288 words). Execution time for the entire testing set was 34.14 minutes for the baseline control system and 37.06 minutes for the above method.

The baseline control system was based on the CMU Sphinx 3 open-source toolkit for speech recognition, produced by Carnegie Mellon University of Pittsburgh, Pa. The control system was specifically an Arabic speech recognition system. The baseline control system used three-emitting states hidden Markov models for triphone-based acoustic models. The state probability distribution used a continuous density of eight Gaussian mixture distributions. The baseline system was trained using audio files recorded from several television news channels at a sampling rate of 16,000 samples per second.

Two speech corpuses were used for training. The first speech corpus contained 249 business/economics and sports stories (144 by male speakers, 105 by female speakers), having a total of 5.4 hours of speech. The 5.4 hours (1.1 hours used for testing) were split into 4,572 files having an average file length of 4.5 seconds. The length of individual .wav audio files ranged from 0.8 seconds to 15.6 seconds. An additional 0.1 second silence period was added to the beginning and end of each file. The 4,572 .wav files were completely transcribed with fully diacritized text. The transcription was meant to reflect the way the speaker had uttered the words, even if they were grammatically incorrect. It is a common practice in most Arabic dialects to drop the vowels at the end of words. This situation was represented in the transcription by either using a silence mark (“Sukun” or unvowelled) or dropping the vowel, which is considered equivalent to the silence mark. The transcription file contained 39,217 words. The vocabulary list contained 14,234 words. The baseline (first speech corpus) WER was 12.21% using Sphinx 3.

The second speech corpus contained 7.57 hours of speech (0.57 hours used for testing). The recorded speech was divided into 6,146 audio files. There was a total of 52,714 words, and a vocabulary of 17,236 words. The other specifications were the same as in the first speech corpus. The baseline (second corpus) system WER was found to be 16.04%.

A method of cross-word decoding in speech recognition is further provided. The cross-word method utilizes a knowledge-based approach, particularly using two phonological rules common in Arabic speech, namely, the rules of merging (Idgham) and changing (Iqlaab). As in the previous method, this method makes primary use of the pronunciation dictionary 20 and the language model 22. The dictionary and the language model are both expanded according to the cross-word eases found in the corpus transcription. This method is based on the compounding of words, as described above.

In this method, cross-word starts are identified and extracted from the corpus transcription. The phonological rules to be applied are then specified. In this particular case, the rules are merging (Idgham) and changing (Iqlaab). A software tool is then used to extract the compound words from the baseline corpus transcription. Following extraction of the compound words, the compound words are then added to the corpus transcription within their sentences. The original sentences (i.e., without merging) remain in the enhanced corpus transcription. This method maintains both cases of merged and separated words.

The enhanced corpus is then used to build the enhanced dictionary. The language model is built according to the enhanced corpus transcription. In other words, the compound words in the enhanced corpus transcription will be involved in the unigrams, bigrams, and trigrams of the language model. Then, during the recognition process, the recognition result is scanned for decomposing compound words to their original state (i.e., two separated words). This is performed using a lookup table.

This method for modeling cross-word decoding is described by Algorithm 1 below:

Algorithm 1: Cross-Word Modeling Using Phonological Rules

```
For all sentences in the transcription file
    For each two adjacent words of each sentence
        If the adjacent words satisfy a phonological rule
            Generate the compound word
            Represent the compound word in the transcription
        End if
    End for
End for
Based on the new transcription, build the enhanced dictionary
Based on the new transcription, build the enhanced language model
```

In Algorithm 1, all steps are performed offline. Following this process, there is an online stage of switching the variants back to their original separated words. In order to test this method, both the phonological rules of Idgham and Iqlaab were used. Three Arabic speech recognition metrics were measured: word error rate (WER), out-of-vocabulary (OOV), and perplexity (PP). The above method produced a WER of 9.91%, compared to a WER of 12.21% for a baseline control speech recognition method. The baseline control system produced an OOV of 3.53% and the above method produced an OOV of 2.89%. Further, perplexity for the baseline control system was 34.08, while the perplexity of the above method was 4.00. The measurement was performed on a testing set of 9,288 words. The overall execution time was found to be 34.14 minutes for the baseline control system, and 33.49 minutes for the above method.

In an alternative method, two pronunciation cases are considered, which include nouns followed by an adjective, and prepositions followed by any word. This is of particular interest when it is desired to compound some words as one word. This method is based on the Arabic tags generated by the Stanford Part-of-Speech (PoS) Arabic language tagger, created by the Stanford Natural Language Processing Group of Stanford University, of Stanford Calif., which consists of twenty-nine different tags. The tagger output is used to generate compound words by searching for noun-adjective and preposition-word sequences.

This method for modeling cross-word decoding is described by Algorithm 2 below:

Algorithm 2: Cross-Word Modeling Using Tags Merging

```
Using a PoS tagger, have the transaction corpus tagged
For all sentences in the transcription file
    For each two adjacent tags of each tagged sentence
        If the adjacent tags are adjective/noun or word/preposition
            Generate the compound word
            Represent the compound word in the transcription
        End if
    End for
End for
Based on the new transcription, build the enhanced dictionary
Based on the new transcription, build the enhanced language model
```

In Algorithm 2, all steps are performed offline. Following this process, there is an online stage of switching the variants back to their original separated words. In order to test this method, both the phonological rules of Idgham and Iqlaab were used. Three Arabic speech recognition metrics were measured, including word error rate (WER), out-of-vocabulary (OOV), and perplexity (PP). Using WER, the baseline control method was found to have an accuracy of 87.79%. The above method for the noun-adjective case had an accuracy of 90.18%. For the preposition-word case, the above method produced an accuracy of 90.04%. For a hybrid case of both noun-adjective and preposition-word, the above method had an accuracy of 90.07%.

The baseline control system produced an OOV of 3.53% and a perplexity of 34.08, while the above method produced an OOV of 3.09% and a perplexity of 3.00 for the noun-adjective case. For the preposition case, the above method had an OOV of 3.21% and a perplexity of 3.22. For a hybrid model of both noun-adjective and preposition, the above method had an accuracy of 3.40% and a perplexity of 2.92. The execution time in the baseline control system was 34.14 minutes, while execution time using the above method was 33.05 minutes. Table 4 below shows statistical information for compound words with the above method.

TABLE 4
Statistical Information for Compound Words

| | | Compound | Unique | Compound |
|---|---|---|---|---|
| | | Words | Compound | Words |
| Experiment # | Experiment | Collected | Words | Replaced |
| 1 | Noun- | 3,328 | 2,672 | 377 |
| | Adjective | | | |
| 2 | Preposition | 3,883 | 2,297 | 409 |
| 3 | Hybrid | 7,211 | 4,969 | 477 |

As a further alternative, cross-word modeling may be performed by using small word merging. Unlike isolated speech, continuous speech is known to be a source of augmenting words. This augmentation depends on many factors, such as the phonology of the language and the lengths of the words. Decoding may therefore be focused on adjacent small words as a source of the merging of words. Modeling of the small-word problem is a data-driven approach in which a compound word is distilled from the corpus transcription. The compound word length is the total length of the two adjacent small words that form the corresponding compound word. The small word's length could be 2, 3, or 4 or more letters.

This method for modeling cross-word decoding is described by Algorithm 3 below:

Algorithm 3: Cross-Word Modeling Using Small Words

```
For all sentences in the transcription file
    For each two adjacent tags of each tagged sentence
        If the adjacent words are less than a certain threshold
            Generate the compound word
            Represent the compound word in the transcription
        End if
    End for
End for
Based on the new transcription, build the enhanced dictionary
Based on the new transcription, build the enhanced language model
```

In Algorithm 3, all steps are performed offline. Following this process, there is an online stage of switching the variants back to their original separated words. Table 5 below shows the results of nine experiments. The factors include total length of the two adjacent small words (TL), total compound words found in the corpus transcription (TC), total unique compound words without duplicates (TU), total replaced words after the recognition process (TR), accuracy achieved (AC), and enhancement (over the baseline control system) achieved (EN). EN is also the reduction in WLR from the baseline system to the system of the above method.

TABLE 5
Results for Various Small Word Length

| TL | TC | TU | TR | AC (%) | EN (%) |
|---|---|---|---|---|---|
| 5 | 8 | 6 | 25 | 87.80 | 0.01 |
| 6 | 103 | 48 | 41 | 88.23 | 0.44 |
| 7 | 235 | 153 | 51 | 88.53 | 0.74 |
| 8 | 794 | 447 | 132 | 89.42 | 1.63 |
| 9 | 1,618 | 985 | 216 | 89.74 | 1.95 |
| 10 | 3,660 | 2,153 | 374 | 89.95 | 2.16 |
| 11 | 5,805 | 3,687 | 462 | 89.69 | 1.90 |
| 12 | 8,518 | 5,776 | 499 | 89.68 | 1.89 |
| 13 | 11,785 | 8,301 | 510 | 88.92 | 1.13 |

The perplexity of the baseline control model was 32.88, based on 9,288 words. For the above method, the perplexity was 7.14, based on the same set of 9,288 testing words. Table 6 shows a comparison between the three cross-word modeling approaches.

TABLE 6
Comparison Among Cross-Word Modeling Methods

| | | | Execution Time |
|---|---|---|---|
| # | Method | Accuracy (%) | (minutes) |
| 1 | Baseline | 87.79 | 34.14 |
| 2 | Phonological Rules | 90.09 | 33.49 |
| 3 | PoS Tagging | 90.18 | 33.05 |
| 4 | Small Word Merging | 89.95 | 34.31 |
| | Hybrid System (# 1, 2 and 3) | 88.48 | 30.31 |

By combining both within-word decoding and the cross-word methods, an accuracy of 90.15% was achieved, with an execution time of 32.17 minutes. Improving speech recognition accuracy through linguistic knowledge is a major research area in automatic speech recognition systems. Thus, a further alternative method uses a syntax-mining approach to rescore N-best hypotheses for Arabic speech recognition systems. The method depends on a machine learning tool, such as the Weka® 3-6-5 machine learning system, produced by WaikatoLink Limited Corporation of New Zealand, to extract the N-best syntactic rules of the baseline tagged transcription corpus, which is preferably tagged using the Stanford Arabic tagger. The syntactically incorrect output structure problem appears in the form of different orders of words, so that the words are out of the Arabic correct syntactic structure.

In this situation, a baseline output sentence is used. The output sentence (released to the user) is the first hypothesis, while the correct sentence is the second hypothesis. These sentences are referred to as the N-best hypotheses (also sometimes called the “N-best list”). To model this problem (i.e., out of language syntactic structure results), the tags of the words are used as a criterion for rescoring and sorting the N-best list. The tags use the word's properties instead of the word itself. The rescored hypotheses are then sorted to pick the top score hypothesis.

The rescoring process is performed for each hypothesis to find the new score. A hypothesis new score is the total number of the hypothesis' rules that are already found in the language syntax rules (extracted from the tagged transcription corpus). The hypothesis with the maximum matched rules is considered as the best one. Each hypothesis is evaluated by finding the total number of the hypothesis' rules already found in the language syntax rules. Since the N-best hypotheses are sorted according to the acoustic score, if two hypotheses have the same matching rules, the first one will be chosen, since it has the highest acoustic score. Therefore, two factors contribute to decide which hypothesis in the N-best list would be the best one, namely, the acoustic score and the total number of language syntax rules belonging to the hypothesis.

This method for N-best hypothesis rescoring is described by Algorithm 4 below:

Algorithm 4: N-best Hypothesis Restoring

```
Have the transcription corpus tagged
Using the tagged corpus, extract N-best rules
Generate the N-best hypotheses for each tested file
Have the N-best hypotheses tagged for tested files
For each tested file
    For each hypothesis in the tested files
        Count the total number of matched rules
    Return the hypothesis of the maximum matched rules
    End for
End for
```

in Algorithm 4, the “matched rules” are the hypothesis rules that are also found in the language syntax rules.

It is to be understood that the present invention is not limited to the embodiments described above, but encompasses any and all embodiments within the scope of the following claims.

We claim:

1. A computer software product that includes a computer readable media readable by a processor, the computer readable media having stored thereon a set of instructions for performing decoding of speech, the instructions comprising:
(a) a first set of instructions which, when loaded into main memory and executed by the processor, causes the processor to establish a pronunciation dictionary for a particular language and store the pronunciation dictionary in computer readable memory, the pronunciation dictionary including a plurality of words, each of the words being divided into phonemes of the language, each of the phonemes being represented by a single character;
(b) a second set of instructions which, when loaded into main memory and executed by the processor, causes the processor to train an acoustic model for the language, the acoustic model including hidden Markov models corresponding to the phonemes of the language;
(c) a third set of instructions which, when loaded into main memory and executed by the processor, causes the processor to store the trained acoustic model in the computer readable memory;
(d) a fourth set of instructions which, when loaded into main memory and executed by the processor, causes the processor to train a language model for the language, the language model being an N-gram language model containing probabilities of particular word sequences from a transcription corpus;
(e) a fifth set of instructions which, when loaded into main memory and executed by the processor, causes the processor to store the trained language model in the computer readable memory;
(f) a sixth set of instructions which, when loaded into main memory and executed by the processor, causes the processor to receive at least one spoken word in the language and generate a digital speech signal corresponding the at least one spoken word;
(g) a seventh set of instructions which, when loaded into main memory and executed by the processor, causes the processor to perform phoneme recognition on the speech signal to generate a set of spoken phonemes of the at least one word, the set of spoken phonemes being recorded in the computer readable memory, wherein each of the spoken phonemes is represented by a single character;
(h) an eighth set of instructions which, when loaded into main memory and executed by the processor, causes the processor to perform sequence alignment between the spoken phonemes of the at least one word and a set of reference phonemes of the pronunciation dictionary corresponding to the at least one word;
(i) a ninth set of instructions which, when loaded into main memory and executed by the processor, causes the processor to compare the spoken phonemes of the at least one word and the set of reference phonemes of the pronunciation dictionary corresponding to the at least one word to identify a set of unique variants; and
(j) a tenth set of instructions which, when loaded into main memory and executed by the processor, causes the processor to update the pronunciation dictionary and the language model by adding the set of unique variants thereto and recording the updated pronunciation dictionary and the language model in the computer readable memory.

2. The computer software product as recited in claim 1, further comprising an eleventh set of instructions which, when loaded into main memory and executed by the processor, causes the processor to remove duplicate unique variants from the set of unique variants prior to the tenth set of instructions.

3. The computer software product as recited in claim 2, further comprising a twelfth set of instructions which, when loaded into main memory and executed by the processor, causes the processor to generate orthographic forms for each said unique variant in the set of unique variants.

4. A computer software product that includes a computer readable media readable by a processor, the computer readable media having stored thereon a set of instructions for performing decoding of speech, the instructions comprising:
(a) a first set of instructions which, when loaded into main memory and executed by the processor, causes the processor to establish a pronunciation dictionary for a particular language and store the pronunciation dictionary in computer readable memory, said pronunciation dictionary including a plurality of words each divided into phonemes of the language;
(b) a second set of instructions which, when loaded into main memory and executed by the processor, causes the processor to train an acoustic model for the language, the acoustic model including hidden Markov models corresponding to the phonemes of the language;
(c) a third set of instructions which, when loaded into main memory and executed by the processor, causes the processor to store the trained acoustic model in the computer readable memory;
(d) a fourth set of instructions which, when loaded into main memory and executed by the processor, causes the processor to train a language model for the language, the language model being an N-gram language model containing probabilities of particular word sequences from a transcription corpus;
(e) a fifth set of instructions which, when loaded into main memory and executed by the processor, causes the processor to store the trained language model in the computer readable memory;
(f) a sixth set of instructions which, when loaded into main memory and executed by the processor, causes the processor to receive at least one sentence including a plurality of words in the language and generate a digital speech signal corresponding the at least one sentence;
(g) a seventh set of instructions which, when loaded into main memory and executed by the processor, causes the processor to perform phoneme recognition on the speech signal to generate a set of spoken phonemes of each of the words of the at least one sentence, said set of spoken phonemes being recorded in the computer readable memory;
(h) an eighth set of instructions which, when loaded into main memory and executed by the processor, causes the processor to compare the spoken phonemes of the words of the at least one sentence and the set of reference phonemes of the pronunciation dictionary corresponding to the at least one word to form a transcription of the at least one sentence, the transcription being recorded in the computer readable memory;
(i) a ninth set of instructions which, when loaded into main memory and executed by the processor, causes the processor to analyze each pair of adjacent words of the at least one sentence to identify a phonological rule selected from the group consisting of merging and changing;
(j) a tenth set of instructions which, when loaded into main memory and executed by the processor, causes the processor to, upon identification of the phonological rule in at least one pair of the adjacent words, form at least one compound word to replace the at least one pair of words in the transcription; and
(k) an eleventh set of instructions which, when loaded into main memory and executed by the processor, causes the processor to update the pronunciation dictionary and the language model by adding the at least one compound word thereto and recording the updated pronunciation dictionary and the language model in the computer readable memory.

5. The computer software product as recited in claim 4, further comprising a twelfth set of instructions which, when loaded into main memory and executed by the processor, causes the processor to replace the at least one compound word in the transcription with the original pair of adjacent words corresponding thereto, following the eleventh set of instructions.

6. A computer software product that includes a computer readable media readable by a processor, the computer readable media having stored thereon a set of instructions for performing decoding of speech, the instructions comprising:
(a) a first set of instructions which, when loaded into main memory and executed by the processor, causes the processor to establish a pronunciation dictionary for a particular language and store the pronunciation dictionary in computer readable memory, said pronunciation dictionary including a plurality of words each divided into phonemes of the language;
(b) a second set of instructions which, when loaded into main memory and executed by the processor, causes the processor to train an acoustic model for the language, the acoustic model including hidden Markov models corresponding to the phonemes of the language;
(c) a third set of instructions which, when loaded into main memory and executed by the processor, causes the processor to store the trained acoustic model in the computer readable memory;
(d) a fourth set of instructions which, when loaded into main memory and executed by the processor, causes the processor to train a language model for the language, the language model being an N-gram language model containing probabilities of particular word sequences from a transcription corpus;
(e) a fifth set of instructions which, when loaded into main memory and executed by the processor, causes the processor to store the trained language model in the computer readable memory;
(f) a sixth set of instructions which, when loaded into main memory and executed by the processor, causes the processor to receive at least one sentence including a plurality of words in the language and generate a digital speech signal corresponding the at least one sentence;
(g) a seventh set of instructions which, when loaded into main memory and executed by the processor, causes the processor to perform phoneme recognition on the speech signal to generate a set of spoken phonemes of each of the words of the at least one sentence, said set of spoken phonemes being recorded in the computer readable memory;
(h) an eighth set of instructions which, when loaded into main memory and executed by the processor, causes the processor to compare the spoken phonemes of the words of the at least one sentence and the set of reference phonemes of the pronunciation dictionary corresponding to the at least one word to form a transcription of the at least one sentence, the transcription being recorded in the computer readable memory;
(i) a ninth set of instructions which, when loaded into main memory and executed by the processor, causes the processor to apply a part-of-speech tagger to the transcription and analyze each pair of adjacent tagged words of the at least one sentence to identify tagged words selected from the group consisting of adjective-noun words and word-preposition words;
(j) a tenth set of instructions which, when loaded into main memory and executed by the processor, causes the processor to, upon identification of the tagged words in at least one pair of the adjacent tagged words, form at least one compound word to replace the at least one pair of tagged words in the transcription; and
(k) an eleventh set of instructions which, when loaded into main memory and executed by the processor, causes the processor to update the pronunciation dictionary and the language model by adding the at least one compound word thereto and recording the updated pronunciation dictionary and the language model in the computer readable memory.

7. The computer software product as recited in claim 6, further comprising a twelfth set of instructions which, when loaded into main memory and executed by the processor, causes the processor to replace the at least one compound word in the transcription with the original pair of adjacent tagged words corresponding thereto, following the eleventh set of instructions.
